(19) United States
(12) Patent Application Publication
(10) Pub. No.: US 2026/0075108 A1
(43) Pub. Date: Mar. 12, 2026

(54) WIRELESS AND MODULAR DATA COLLECTION SYSTEM WITH SENSOR IC INTEGRATION CAPABILITY

(71) Applicant: Ryan Berube, Millis, MA (US)

(72) Inventor: Ryan Berube, Millis, MA (US)

(21) Appl. No.: 18/882,008

(22) Filed: Sep. 11, 2024

(51) Int. Cl. H04L 67/12; H04L 67/02; H04W 84/18

(52) U.S. Cl. CPC H04L 67/12; H04L 67/02; H04W 84/18

(57) ABSTRACT

The invention provides a wireless and modular data collection system for industrial applications. It includes a hub with dual microcontrollers: one managing a mesh network for communication with sensor nodes, and another handling data caching and transmission to a network-accessible server. Sensor nodes are modular and interchangeable, each with a microcontroller that formats data from various sensors for mesh network transmission. The system enables real-time data monitoring via a web-based interface and supports automatic authentication and connection of sensor nodes. This design enhances data collection efficiency, simplifies integration, and scales easily with new sensors, addressing limitations of traditional methods.

### FIELD

The present application relates to the field of data collection systems used in industrial settings. More specifically, it pertains to a versatile data collection for engineers and other professionals enabling efficient and adaptable data gathering across various industrial applications.

### BACKGROUND

In industrial settings, data collection is crucial for monitoring, analyzing, and optimizing various processes and equipment. Traditionally, industrial data collection has relied on specialized instruments and manual methods, which can be cumbersome and inflexible. Many existing systems require dedicated hardware for each type of sensor or data source, leading to increased complexity and difficulty in integrating new sensors or adapting to changing requirements.

Existing data collection systems often suffer from several limitations:
1. Limited Versatility: Conventional systems are typically designed for specific types of sensors or data sources, making it challenging to incorporate new or different sensors without significant modifications.
2. Complex Integration: Integrating various sensors into a unified system often involves complex wiring and setup, which can be time-consuming and error-prone.
3. Scalability Issues: Many traditional systems are not easily scalable, making it difficult to expand the data collection network as new sensors or data points are added.
4. Lack of Adaptability: Existing systems may not easily adapt to different industrial applications or environments, reducing their overall utility.

Therefore, there is a need for a more versatile and adaptable data collection system that can seamlessly integrate with various types of sensors, simplify the setup and integration process, and easily scale to accommodate new data sources. Such a system would enhance the efficiency and effectiveness of data collection in industrial settings, providing engineers and professionals with a more flexible and user-friendly tool for managing their data.

### SUMMARY

The present invention addresses these needs by providing a versatile data collection system designed to function as a “multi-tool,” capable of integrating with a wide range of sensors and data sources while offering a streamlined and adaptable solution for industrial data collection.

The disclosed embodiment of the system depicts the basic architecture of the system. In one diagram, an overall view is provided, showing what makes up the system as a whole and by what means each part of the system communicates with each other.

The other diagram depicts just a sensor node in order to demonstrate how the actual sensor is interchangeable as long as the microcontroller is programmed to accommodate. This allows any sensor type to be easily integrate-able into the system.

### BRIEF DESCRIPTION OF THE DRAWINGS

In the following detailed portion of the present description, the teachings of the present application will be explained in more detail with reference to the example embodiment shown in the drawing, in which:

FIG. 1. is a diagram showing the overall architecture of the system,

FIG. 2. is a diagram showing just a sensor node and its architecture.

### DETAILED DESCRIPTION

In the following detailed description, the system according to the teachings for this application will be described following the diagram. It should be noted that even though the system architecture in these teachings is described in terms of a data acquisition system, it can be used for many web to network of hub managed device applications.

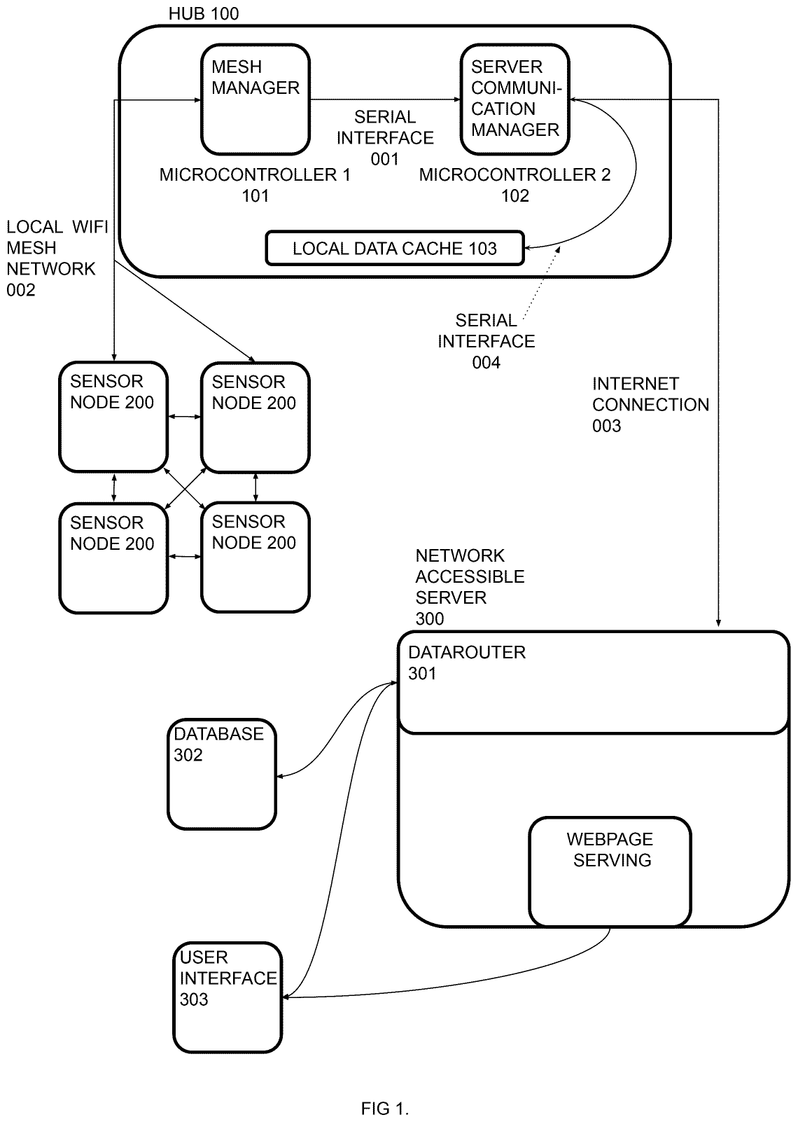

In FIG. 1., the hub 100, manages the hardware system. The hub has two WiFi and internet capable microcontrollers 101 and 102. Microcontroller 101 manages the WiFi mesh network 002. It coordinates sending of data and receives data from a network of sensor nodes 200. Use of a mesh network 002 allows extended range and lower potential for data loss. Microcontroller 101 also after receiving data passes it to microcontroller 102 over serial interface 001. The specific serial interface isn't extremely important, I2C or UART has been used. Microcontroller 102 caches data to a local data cache 103, for which a flash chip has been used, over serial interface 004. For serial interface 004, SPI is typically used. Over internet connection 003, either through WiFi or ethernet, microcontroller 102 sends the packaged data to network accessible server 300 with a datarouter 301. The datarouter 301 routes the data to the database 302. An end user can access a data interface with live graphs and historical data through a webpage serving user interface 303. User interface 303 can interact with the datarouter 301 in order to pull live and historical data. It is worth noting that the user interface 303 can through the network accessible server 300 pass commands to microcontroller 102 which allows control over essential hub functions remotely.

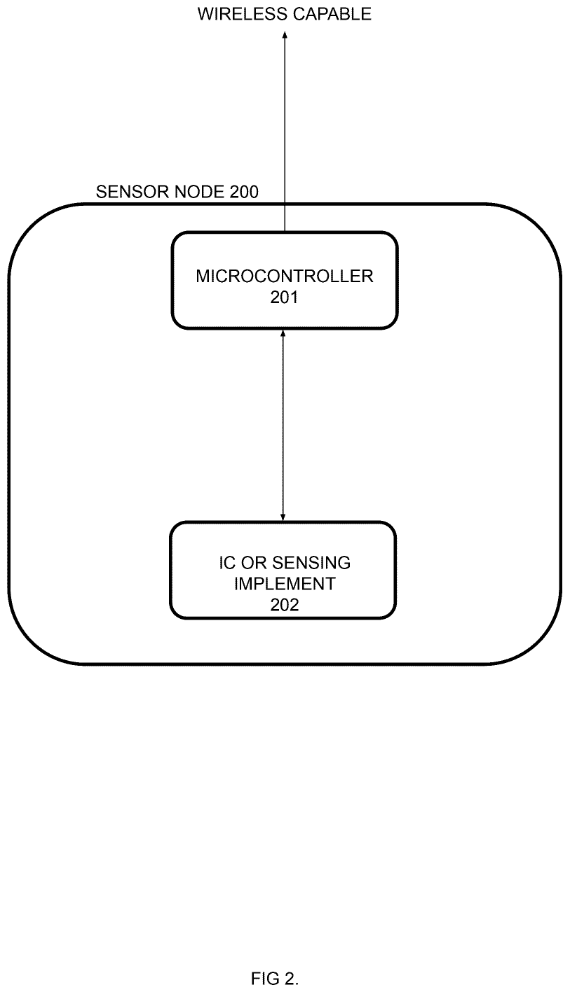

In FIG. 2., the sensor node 200 is depicted. Microcontroller 201 is what allows the sensor node 200 to communicate on the mesh network 002 depicted in FIG. 1.. The microcontroller can be programmed to package any type of data received from a sensing implement 202 into an acceptable format for it to be transmitted on the mesh network. Data from the sensing implement 202 can be anything as long as the microcontroller chosen has the facilities to accommodate (ADC, SPI, I2C, UART). This is what gives the system its versatility and allows it to accommodate any data type. The microcontroller 201 can also be programmed to recognize and authenticate itself on the mesh network, if the mesh network managed by microcontroller 101 accommodates it. If microcontroller 101 allows any connection but requires connecting microcontrollers to authenticate themselves with an encrypted passkey, sensor nodes 200 can automatically connect themselves, allowing the end user to have no need to set up sensor nodes. If a sensor node 200 automatically connects when it powers on through this system, it adds another level of convenience for the end user.

When manufactured, both the hub 100 and sensor node 200 sit on separate PCBs. Firmware for all microcontrollers has not been explicitly described but because the general function is, those skilled in the art are able to reproduce the general function. Furthermore, the mediums of communicating in the system has not been specified, only generally referred to, because the function of the system is not contingent on the type of medium.

1. A wireless and modular data collection system comprising:
a. a hub configured to manage data acquisition and communication;
b. a mesh network managed by a first microcontroller within the hub, enabling communication with multiple sensor nodes;
c. a second microcontroller within the hub configured to cache data received from the first microcontroller and transmit the cached data to a network-accessible server;
d. one or more sensor nodes each including a microcontroller and a sensing implement, wherein the microcontroller is programmed to format data from the sensing implement for transmission over the mesh network.

2. The system of claim 1, wherein the hub further includes a local data cache implemented using a flash memory chip, and the second microcontroller communicates with the local data cache via a serial interface selected from the group consisting of I2C, UART, and SPI.

3. The system of claim 1, wherein the sensor nodes are modular and interchangeable, and the microcontroller in each sensor node is programmable to accommodate different types of sensing implements and communication protocols including ADC, SPI, I2C, and UART.

4. The system of claim 1, wherein the network-accessible server includes a data router for routing data to a database, and a user interface that provides live graphs and historical data accessible via a web page.

5. The system of claim 1, wherein the sensor nodes are capable of authenticating themselves on the mesh network using an encrypted passkey if required by the first microcontroller, and can automatically connect to the network upon power-up.
